(19) United States
(12) Patent Application Publication
(10) Pub. No.: US 2016/0092117 A1
(43) Pub. Date: Mar. 31, 2016

(54) REDUCTION OF PERFORMANCE IMPACT OF UNEVEN CHANNEL LOADING IN SOLID STATE DRIVES

(71) Applicant: INTEL CORPORATION, SANTA CLARA, CA (US)

(72) Inventors: Anand S. RAMALINGAM, Beaverton, OR (US); Vasantha M. SRIRANJANI, Folsom, CA (US)

(21) Appl. No.: 14/499,016

(22) Filed: Sep. 26, 2014

(51) Int. Cl. G06F 3/06

(52) U.S. Cl. CPC G06F 3/0613; G06F 3/0635; G06F 3/0679

(57) ABSTRACT

Provided are a method and system for allocating read requests in a solid state drive coupled to a host. An arbiter in the solid state drive determines which of a plurality of channels in the solid state drive is a lightly loaded channel of a plurality of channels. Resources for processing one or more read requests intended for the determined lightly loaded channel are allocated, wherein the one or more read requests have been received from the host. The one or more read requests are placed in the determined lightly loaded channel for the processing. In certain embodiments, the lightly loaded channel is the most lightly loaded channel of the plurality of channels.

### BACKGROUND

A solid state drive (SSD) is a data storage device that uses integrated circuit assemblies as memory to store data persistently. Many type of SSDs use NAND-based or NOR-based flash memory which retains data without power and is a type of non-volatile storage technology.

Communication interfaces may be used to couple SSDs to a host system comprising a processor. Such communication interfaces may include a Peripheral Component Interconnect Express (PCIe) bus. Further details of PCIe may be found the publication entitled, “PCI Express Base Specification Revision 3.0,” published on Nov. 10, 2010, by PCI-SIG. The most important benefit of SSDs that communicate via the PCI bus is increased performance, and such SSDs are referred to as PCIe SSD.

### BRIEF DESCRIPTION OF THE DRAWINGS

Referring now to the drawings in which like reference numbers represent corresponding parts throughout:

FIG. 1 illustrates a block diagram of a computing environment in which a solid state disk is coupled to a host over a PCIe bus;

FIG. 2 illustrates another block diagram that shows how an arbiter allocates read requests in an incoming queue to channels of a solid state drive, in accordance with certain embodiments;

FIG. 3 illustrates a block diagram that shows allocation of read requests in a solid state drive before starting prioritization of the most lightly populated channel and a reordering of host commands, in accordance with certain embodiments;

FIG. 4 illustrates a block diagram that shows allocation of read requests in a solid state drive after prioritization of the most lightly populated channel and a reordering of host commands, in accordance with certain embodiments;

FIG. 5 illustrates a first flowchart for preventing uneven channel loading in solid state drives, in accordance with certain embodiments;

FIG. 6 illustrates a second flowchart for preventing uneven channel loading in solid state drives, in accordance with certain embodiments; and

FIG. 7 illustrates a block diagram of computational device, in accordance with certain embodiments.

### DETAILED DESCRIPTION

In the following description, reference is made to the accompanying drawings which form a part hereof and which illustrate several embodiments. It is understood that other embodiments may be utilized and structural and operational changes may be made.

The increased performance of PCIe SSDs may be primarily because of the number of channels implemented in the PCIe SSDs. For example, in certain embodiments, certain PCIe SSDs may provide improved internal bandwidth via an expanded 18-channel design.

In a PCIe based solid state drive, the PCIe bus from the host to the solid state drive may have a high bandwidth (e.g., 40 gigabytes/second). The PCIe based solid state drive may have a plurality of channels where each channel has a relatively lower bandwidth in comparison to the bandwidth of the PCIe bus. For example, in a solid state drive with 18 channels, each channel may have a bandwidth of about 200 megabytes/second.

In certain situations, the number of NAND chips that are coupled to each channel are equal in number, and in such situations, in case of random but uniform read requests from the host, the channels may be loaded roughly equally, i.e., each channel over a duration of time is utilized roughly the same amount for processing read requests. It may be noted that in many situations, more than 95% of the requests from the host to the solid state drive may be read requests, whereas less than 5% of the requests from the host to the solid state drive may be write requests and proper allocation of read requests to channels may be of importance in solid state drives.

However, in certain situations, at least one of the channels may have a different number of NAND chips coupled to the channel in comparison to the other channels. Such a situation may occur when the number of NAND chips is not a multiple of the number of channels. For example, if there are 18 channels and the number of NAND chips is not a multiple of 18, then at least one of the channels must have a different number of NAND chips coupled to the channel, in comparison to the other channels. In such situations, channels that are coupled to a greater number of NAND chips may be loaded more heavily than channels that coupled to a fewer number of NAND chips. It is assumed that each NAND chip in the solid state drive is of identical construction and has the same storage capacity.

In case of uneven loading of channels, some channels may be backlogged more than other and the PCIe bus may have to wait for the backlog to clear before completing the response to the host

Certain embodiments provide mechanisms to prevent uneven loading of channels even when at least one of the channels has a different number of NAND chips coupled to the channel in comparison to the other channels. This is achieved by preferentially loading the most lightly loaded channel with read requests intended for the most lightly loaded channel, and by reordering the processing of pending read requests awaiting execution in a queue in the solid state drive. Since resources are allocated when a read request is loaded onto a channel, by loading the most lightly loaded channels with read requests, resources are used only when needed and are used efficiently. As a result, certain embodiments improve the performance of SSDs.

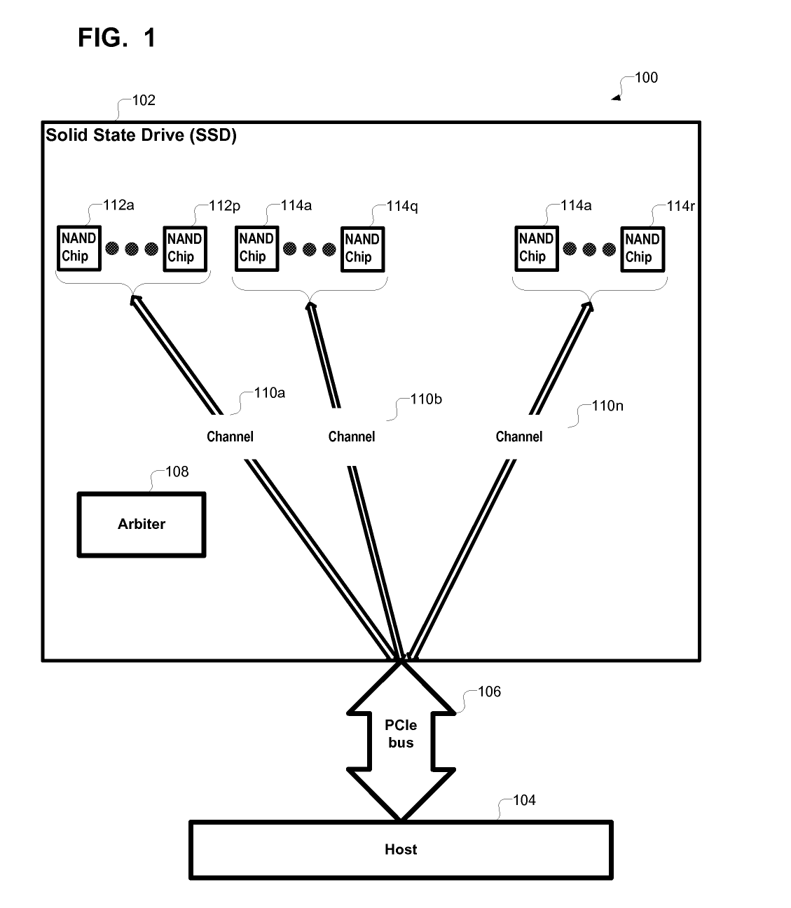

FIG. 1 illustrates a block diagram of a computing environment 100 in which a solid state drive 102 is coupled to a host 104 over a PCIe bus 106, in accordance with certain embodiments. The host 104 may be comprised of at least a processor.

In certain embodiments, an arbiter 108 is implemented in firmware in the solid state drive 102. In other embodiments, the arbiter 108 may be implemented in hardware or software, in any combination of hardware, firmware, or software. The arbiter 108 allocates read requests received from the host 104 over the PCIe bus 106 to one or more channels of a plurality of channels 110a, 110b, . . . , 110n of the solid state drive 102.

In certain embodiments, the channels 110a . . . 110n are coupled to a plurality of non-volatile memory chips, such as NAND chips, NOR chips, or other suitable non-volatile memory chips. In alternative embodiments other types of memory chips, such as chips based on phase change memory (PCM), a three dimensional cross point memory, a resistive memory, nanowire memory, ferro-electric transistor random access memory (FeTRAM), magnetoresistive random access memory (MRAM) memory that incorporates memristor technology, spin transfer torque (STT)-MRAM or other suitable memory may also be used.

For example, in certain embodiments, channel 110a is coupled to NAND chips 112a . . . 112p, channel 110b is coupled to NAND chips 114a . . . 114q, and channel 110n is coupled to NAND chips 114a . . . 114r. Each of the NAND chips 112a . . . 112p, 114a . . . 114q, 114a . . . 114r are identical in construction. At least one of the channels of the plurality of channels 110a . . . 110n has a different number of NAND chips coupled to the channel in comparison to other channels, so there is a possibility of uneven loading of the plurality of channels 110a . . . 110n if the read requests from the host 104 are random and uniform.

In certain embodiments, the solid state drive 102 may be capable of storing several terabytes of data or more, and the plurality NAND chips 112a . . . 112p, 114a . . . 114q, 116a . . . 116r, each storing several gigabytes of data or more, may be found in the solid state drive 102. The PCIe bus 106 may have a maximum bandwidth (i.e., data carrying capacity) of 4 gigabytes per second. In certain embodiments, the plurality of channels 110a . . . 110n may be eighteen in number and each channel may have a maximum bandwidth of 200 megabytes per second.

In certain embodiments, the arbiter 108 examines the plurality of channels 110a . . . 110n one by one in a sequence and after examining all of the plurality of channels 110a . . . 110n loads the least loaded channel with read requests intended for the channel to increase the load on the least loaded channel, in an attempt to perform uniform loading of the plurality of channels.

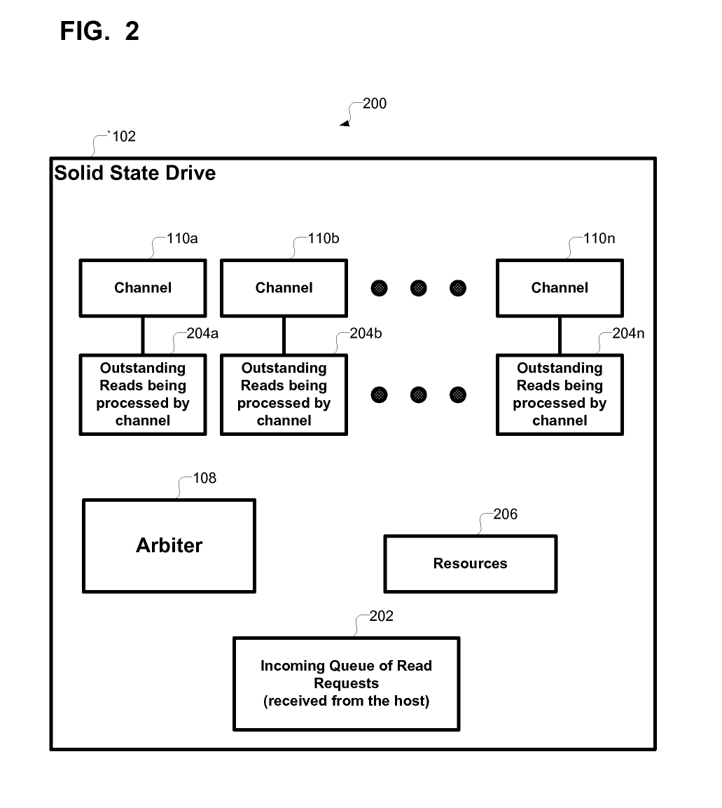

FIG. 2 illustrates another block diagram 200 of the solid state drive 102 that shows how the arbiter 108 allocates read requests in an incoming queue 202 to channels 110a . . . 110n of the solid state drive 102, in accordance with certain embodiments.

The arbiter 108 maintains the incoming queue 202, where the incoming queue 202 stores read request received from the host 104 over the PCIe bus 106. The read requests arrive in an order in the incoming queue 202 and are initially maintained in the same order as the order of arrival of the read requests in the incoming queue 202. For example, a request that arrives first may be for data stored in NAND chips coupled to channel 110b, and a second request that arrives next may be for data stored in NAND chips coupled to channel 110a. In such a situation the request that arrives first is at the head of the incoming queue 202 and the request that arrives next is the next element in the incoming queue 202.

The arbiter 108 also maintains for each channel 110a . . . 110b a data structure in which an identification of outstanding read requests being processed by the channel are kept. For example, the data structures 204a, 204b, . . . 204n store the identification of the outstanding reads being processed by the plurality of channels 110a, 110b, . . . 110n. The outstanding read requests for a channel are the read requests that have been loaded to the channel and that are being processed by the channel, i.e., the NAND chips coupled to the channel are being used to retrieve data corresponding the read requests that have been loaded to the channel.

The solid state drive 102 also maintains a plurality of hardware, firmware, or software resources, such as buffer, latches, memory, various data structures, etc., (as shown via reference numeral 206) that are used when a read request is loaded to a channel. In certain embodiments, by reserving resources at the time of loading read requests on the least loaded channel, the arbiter 108 prevents unnecessary locking up of resources.

Therefore FIG. 2 illustrates certain embodiments in which the arbiter 108 maintains the incoming queue 202 of read requests, and also maintains data structures 204a . . . 204n corresponding to the outstanding reads being processed by each channel 110a . . . 110n of the solid state drive 102.

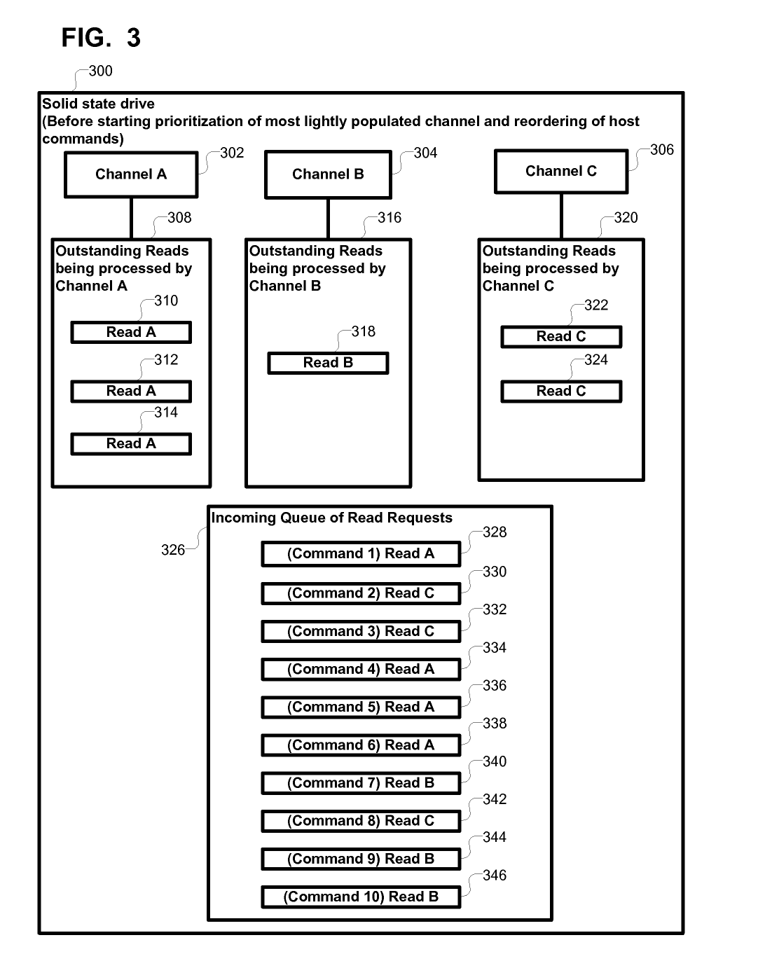

FIG. 3 illustrates a block diagram that shows allocation of read requests in an exemplary solid state drive 300, before starting prioritization of the most lightly populated channel and a reordering of host commands, in accordance with certain embodiments. The most lightly populated channel has the least number of read requests undergoing processing by the channel, in comparison to other channels.

The exemplary solid state drive 300 has three channels: channel A 302, channel B 304, and channel C 306. Channel A 302 has outstanding reads 308 indicated via reference numerals 310, 312, 314, i.e. there are three read requests (referred to as “Read A” 310, 312, 314) for data stored in NAND chips coupled to channel A 302. Channel B 304 has outstanding reads 316 indicated via reference numeral 318, and channel C 306 has outstanding reads 320 referred to by reference numerals 322, 324.

The incoming queue of read requests 326 has ten read commands 328, 330, 332, 334, 336, 338, 340, 342, 344, 346, where the command at the head of the incoming queue 326 is the “Read A” command 328, and the command at the tail of the incoming queue 326 is the “Read B” command 346.

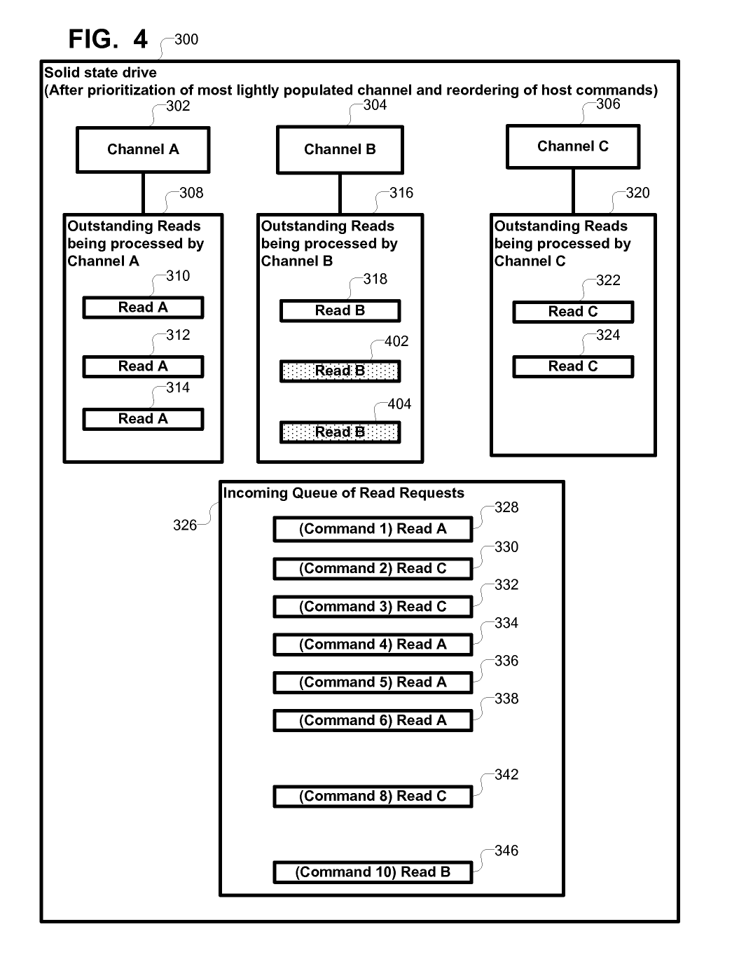

FIG. 4 illustrates a block diagram that shows allocation of read requests in the solid state drive 300 after prioritization of the most lightly populated channel and a reordering of host commands, in accordance with certain embodiments.

In certain embodiments, the arbiter 108 examines the incoming queue of read requests 326 (as shown in FIG. 3) and the outstanding reads being processed by the channels as shown in the data structures 308, 316, 318. The arbiter 108 then loads the most lightly loaded channel B 304 (which has only outstanding one read request 318 in FIG. 3) with the commands 340, 344 (which are “Read B” command) selected out of order from the incoming queue of read requests 326 (as shown in FIG. 3).

FIG. 4 shows the situation after the most lightly loaded channel B 304 has been loaded with command 340, 344. In FIG. 4, reference numerals 402 and 404 in the outstanding reads 316 being processed for channel B 304, show the commands 340, 344 of FIG. 3 that have now been loaded into channel B 304 for processing.

Therefore, the channels 302, 304, and 306 are more evenly loaded by loading the most lightly loaded of the three channels 302, 304, 306 with appropriate read requests selected out of order from the incoming queue of read requests 326. It should be noted that neither of the commands 328, 330, 332, 334, 336, 338 which were ahead of command 340 in the incoming queue 326 can be loaded to channel B 304, as the commands 328, 330, 332, 334, 336, 338 are read requests for data accessed via channel A 302 or channel C 306. It should also be noted that there is only one arbiter 108 and a plurality of channels, so the arbiter 108 examines the outstanding reads 308, 316, 320 on the channels 302, 304, 306 one by one. The channels 302, 304, 306 may of course inform the arbiter 108 when the channels 302, 304, 306 complete processing of certain read requests and the arbiter 108 may keep track of the outstanding read requests on the channels 302, 304, 306 from such information provided by the channels 302, 304, 306.

Additionally, the arbiter 108, when implemented by using a micro controller, is a serialized processor. A NAND chip (e.g. NAND chip 112a) has an inherent property that allows only one read request to it. The channel (e.g., channel 110a) for the NAND chip has a “busy” status until the read request to the NAND chip is complete. It is the responsibility of the arbiter 108 not to schedule a new read while a channel is busy. As soon as the channel is not busy, the arbiter 108 needs to dispatch the next command to the NAND chip. To improve the channel loading, in certain embodiments the arbiter 108 polls the “lightly loaded” channel (i.e., channels that are being used to process relatively fewer read requests) more often than the “heavily loaded” channels (i.e., channels that are being used to process relatively fewer read requests) so that re-ordered read commands are dispatched to lightly loaded channels as soon as possible. This is important because the time to complete a new read command is of the order of 100 micro seconds, while it takes approximately the same amount time for the arbiter 108 to scan all 18 channels and reorder the read commands.

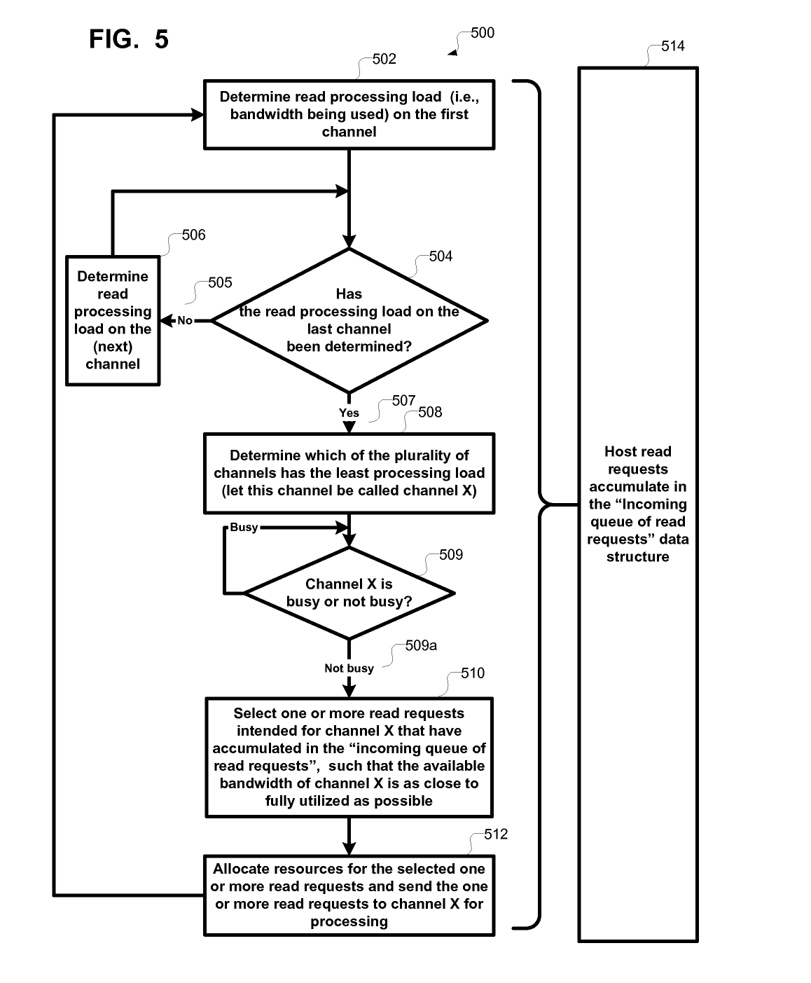

FIG. 5 illustrates a first flowchart 500 for preventing uneven channel loading in solid state drives, in accordance with certain embodiments. The operations shown in FIG. 5 may be performed by the arbiter 108 that performs operations within the solid state drive 102.

Control starts at block 502 in which the arbiter 108 determines the read processing load (i.e., bandwidth being used) on the first channel 110a of a plurality of channels 110a, 110b, . . . 110n. Control proceeds to block 504 in which the arbiter 108 determines whether the read processing load on the last channel 110n has been determined. If not (“No” branch 505), the arbiter 108 determines the read processing load on the next channel and control returns to block 504. The read processing load may be determined by examining the number of pending read requests in the data structure for outstanding reads 204a . . . 204n or via other mechanisms.

If at block 504 a determination is made that the read processing load on the last channel 110n has been determined (“Yes” branch 507) control proceeds to block 508 in which it is determined which of the plurality of channels has the least processing load, and the channel with the least processing load is referred to as channel X.

From block 508 control proceeds to block 509 in which a determination is made as to whether channel X is busy or not busy, where a channel that is busy is not capable of handling additional read requests and a channel that is not busy is capable for handling additional read requests. The determination of whether channel X is busy or not busy is needed because, a NAND chip coupled to channel X has an inherent property that allows only one read request to it. Channel X for the NAND chip has a “busy” status until the read request to the NAND chip is complete.

If at block 509, it is determined that channel X is not busy (reference numeral 509a), then control proceeds to block 510 in which the arbiter 108 selects one or more read requests intended for channel X that have accumulated in the “incoming queue of read requests” 202, such that the available bandwidth of channel X is as close to fully utilized as possible, where the selection may result in a reordering of pending requests in the “incoming queue of read requests” 202. The arbiter 108 allocates resources for the selected one or more read requests and sends (at block 512) the one or more read requests to channel X for processing.

If at block 509 it is determined that channel X is busy (reference numeral 509b) then the process waits till channel X is not busy.

In alternative embodiments, instead of determining the channel which has the least processing load, a relatively lightly loaded channel (i.e., a channel with a relatively low processing load in the plurality of channels) may be determined. In certain embodiments, read requests may be sent preferentially to the relatively lightly loaded channel. It should be noted that the arbiter 108 does not schedule another read request for a lightly loaded channel, until the lightly loaded channel is confirmed as “not busy”.

It may be noted that while operations 502, 504, 505, 506, 507, 508, 510, 512, are being performed the host read requests keep on accumulating (at block 514) in the “incoming queue of read requests” data structure 202.

Therefore, FIG. 5 illustrates certain embodiments for selecting the most lightly loaded channel, and reordering queue items in the incoming queue of read requests to select appropriate read requests to load in the most lightly loaded channel.

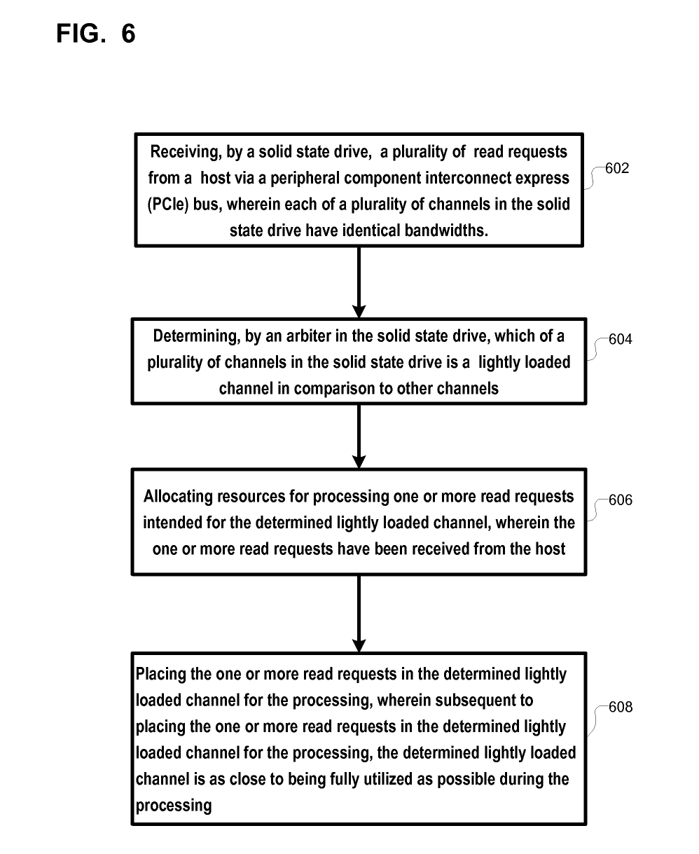

FIG. 6 illustrates a second flowchart 600 for preventing uneven channel loading in solid state drives, in accordance with certain embodiments. The operations shown in FIG. 6 may be performed by the arbiter 108 that performs operations within the solid state drive 102.

Control starts at block 602 in which a solid state drive 102 receives a plurality of read requests from a host 104 via a PCIe bus 106, where each of a plurality of channels 110a . . . 110n in the solid state drive have identical bandwidths. While the channels 110a . . . 110n may have identical bandwidths, in actual scenarios one or more of the channels 110a . . . 110n may not utilize the bandwidth fully.

An arbiter 108 in the solid state drive 102 determines (at block 604) which of a plurality of channels 110a . . . 110n in the solid state drive 102 is a lightly loaded channel (in certain embodiments the lightly loaded channel is the most lightly loaded channel). Resources for processing one or more read requests intended for the determined lightly loaded channel are allocated (at block 608), wherein the one or more read requests have been received from the host 104.

Control proceeds to block 608 in which the one or more read requests are placed in the determined lightly loaded channel for the processing. Subsequent to placing the one or more read requests in the determined lightly loaded channel for the processing, the determined lightly channel is as close to being fully utilized as possible during the processing.

Therefore, FIGS. 1-6 illustrate certain embodiments for preventing uneven loading of channels in a solid state drive by out of order selections of read requests from an incoming queue, and loading the out of order selections of read requests into the channel which is relatively lightly loaded or the least loaded.

The described operations may be implemented as a method, apparatus or computer program product using standard programming and/or engineering techniques to produce software, firmware, hardware, or any combination thereof. The described operations may be implemented as code maintained in a “computer readable storage medium”, where a processor may read and execute the code from the computer storage readable medium. The computer readable storage medium includes at least one of electronic circuitry, storage materials, inorganic materials, organic materials, biological materials, a casing, a housing, a coating, and hardware. A computer readable storage medium may comprise, but is not limited to, a magnetic storage medium (e.g., hard drive drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), Solid State Devices (SSD), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc. The transmission signals in which the code or logic is encoded may further comprise a wireless signal, satellite transmission, radio waves, infrared signals, Bluetooth, etc. The program code embedded on a computer readable storage medium may be transmitted as transmission signals from a transmitting station or computer to a receiving station or computer. A computer readable storage medium is not comprised solely of transmission signals. Those skilled in the art will recognize that many modifications may be made to this configuration, and that the article of manufacture may comprise suitable information bearing medium known in the art.

Computer program code for carrying out operations for aspects of the certain embodiments may be written in any combination of one or more programming languages. Blocks of the flowchart and block diagrams may be implemented by computer program instructions.

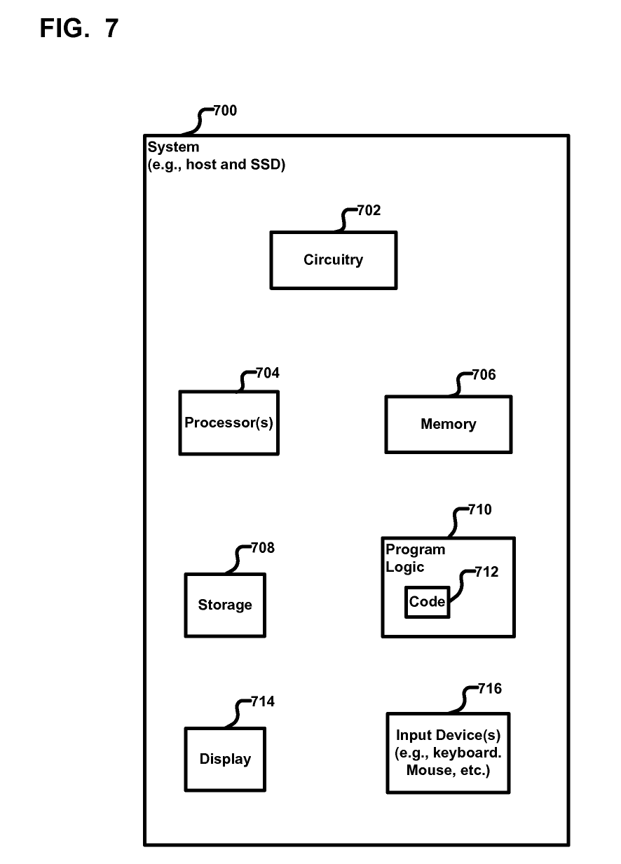

FIG. 7 illustrates a block diagram of a system 700 that includes both the host 104 (the host 104 comprises at least a processor) and the solid state drive 102, in accordance with certain embodiments. For example, in certain embodiments the system 700 may be a computer (e.g., a laptop computer, a desktop computer, a tablet, a cell phone or any other suitable computational device) that has the host 104 and the solid state drive 102 included in the system 700. For example, in certain embodiments the system 700 may be a laptop computer that includes the solid state drive 102.

The system 700 may include a circuitry 702 that may in certain embodiments include at least a processor 704. The system 700 may also include a memory 706 (e.g., a volatile memory device), and storage 708. The storage 708 may include the solid state drive 102 or other drives or devices including a non-volatile memory device (e.g., EEPROM, ROM, PROM, RAM, DRAM, SRAM, flash, firmware, programmable logic, etc.). The storage 708 may also include a magnetic disk drive, an optical disk drive, a tape drive, etc. The storage 708 may comprise an internal storage device, an attached storage device and/or a network accessible storage device. The system 700 may include a program logic 710 including code 712 that may be loaded into the memory 706 and executed by the processor 704 or circuitry 702. In certain embodiments, the program logic 710 including code 712 may be stored in the storage 708. In certain other embodiments, the program logic 710 may be implemented in the circuitry 702. Therefore, while FIG. 7 shows the program logic 710 separately from the other elements, the program logic 710 may be implemented in the memory 706 and/or the circuitry 702. The system 700 may also include a display 714 (e.g., an liquid crystal display (LCD), a light emitting diode (LED) display, a cathode ray tube (CRT) display, a touchscreen display, or any other suitable display). The system 700 may also include one or more input devices 716, such as, a keyboard, a mouse, a joystick, a trackpad, or any other suitable input devices). Other components or devices beyond those shown in FIG. 7 may also be found in the system 700.

Certain embodiments may be directed to a method for deploying computing instruction by a person or automated processing integrating computer-readable code into a computing system, wherein the code in combination with the computing system is enabled to perform the operations of the described embodiments.

The terms “an embodiment”, “embodiment”, “embodiments”, “the embodiment”, “the embodiments”, “one or more embodiments”, “some embodiments”, and “one embodiment” mean “one or more (but not all) embodiments” unless expressly specified otherwise.

The terms “including”, “comprising”, “having” and variations thereof mean “including but not limited to”, unless expressly specified otherwise.

The enumerated listing of items does not imply that any or all of the items are mutually exclusive, unless expressly specified otherwise.

The terms “a”, “an” and “the” mean “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. On the contrary a variety of optional components are described to illustrate the wide variety of possible embodiments.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments need not include the device itself.

At least certain operations that may have been illustrated in the figures show certain events occurring in a certain order. In alternative embodiments, certain operations may be performed in a different order, modified or removed. Moreover, steps may be added to the above described logic and still conform to the described embodiments. Further, operations described herein may occur sequentially or certain operations may be processed in parallel. Yet further, operations may be performed by a single processing unit or by distributed processing units.

The foregoing description of various embodiments has been presented for the purposes of illustration and description. It is not intended to be exhaustive or to be limited to the precise forms disclosed. Many modifications and variations are possible in light of the above teaching.

### Examples

The following examples pertain to further embodiments.

Example 1 is a method in which an arbiter in a solid state drive determines which of a plurality of channels in the solid state drive is a lightly loaded channel in comparison to other channels. Resources are allocated for processing one or more read requests intended for the determined lightly loaded channel, wherein the one or more read requests have been received from a host. The one or more read requests are placed in the determined lightly loaded channel for the processing.

In example 2, the subject matter of claim 1 may include that the determined lightly loaded channel is a most lightly loaded channel in the plurality of channels, wherein subsequent to placing the one or more read requests in the determined most lightly loaded channel for the processing, the determined most lightly loaded channel is as close to being fully utilized as possible during the processing.

In example 3, the subject matter of claim 1 may include that the one or more read requests are included in a plurality of read requests intended for the plurality of channels, wherein an order of processing of the plurality of read requests is modified by the placing of the one or more read requests in the determined lightly loaded channel for the processing.

In example 4, the subject matter of claim 3 may include that modifying the order of processing of the plurality of requests preferentially processes the one or more read requests intended for the determined lightly loaded channel over other requests.

In example 5, the subject matter of claim 1 may include that the solid state drive receives the one or more read requests from the host via a peripheral component interconnect express (PCIe) bus, wherein each of the plurality of channels in the solid state drive has an identical bandwidth.

In example 6, the subject matter of claim 5 may include that a sum of bandwidths of the plurality of channels equals a bandwidth of the PCIe bus.

In example 7, the subject matter of claim 1 may include that at least one of the plurality of channels is coupled to a different number of NAND chips in comparison to other channels of the plurality of channels.

In example 8, the subject matter of claim 1 may include that if the one or more read requests are not placed in the determined lightly loaded channel for the processing then read performance on the solid state drive decreases by over 10% in comparison to another solid state drive in which all channels are coupled to a same number of NAND chips.

In example 9, the subject matter of claim 1 may include that the allocating of the resources for the processing is performed subsequent to determining by the arbiter in the solid state drive which of the plurality of channels in the solid state drive is the lightly loaded channel.

In example 10, the subject matter of claim 1 may include that the arbiter polls relatively lightly loaded channels more often than relatively heavily loaded channels to preferentially dispatch re-ordered read requests to the relatively lightly loaded channels.

In example 11, the subject matter of claim 1 may include associating with each of the plurality of channels a data structure that maintains outstanding reads that are being processed by the channel; and maintaining the one or more read requests that have been received from the host in an incoming queue of read requests received from the host.

Example 12 is an apparatus comprising a plurality of non-volatile memory chips, a plurality of channels coupled to the plurality of non-volatile memory chips, and an arbiter for controlling the plurality of channels, wherein the arbiter is operable to: determine which of the plurality of channels is a lightly loaded channel in comparison to other channels; allocate resources for processing one or more read requests intended for the determined lightly loaded channel, wherein the one or more read requests have been received from a host; and place the one or more read requests in the determined lightly loaded channel for the processing.

In example 13, the subject matter of claim 12 may include that the non-volatile memory chips comprise NAND chips, wherein the determined lightly loaded channel is a most lightly loaded channel in the plurality of channels, wherein subsequent to placing the one or more read requests in the determined most lightly loaded channel for the processing, the determined most lightly loaded channel is as close to being fully utilized as possible during the processing.

In example 14, the subject matter of claim 12 may include that the one or more read requests are included in a plurality of read requests intended for the plurality of channels, wherein an order of processing of the plurality of read requests is modified by the placing of the one or more read requests in the determined lightly loaded channel for the processing.

In example 15, the subject matter of claim 14 may include that modifying the order of processing of the plurality of requests preferentially processes the one or more read requests intended for the determined lightly loaded channel over other requests.

In example 16, the subject matter of claim 12 may include that the apparatus receives the one or more read requests from the host via a peripheral component interconnect express (PCIe) bus, wherein each of the plurality of channels in the apparatus has an identical bandwidth.

In example 17, the subject matter of claim 16 may include that a sum of bandwidths of the plurality of channels equals a bandwidth of the PCIe bus.

In example 18, the subject matter of claim 12 may include that the non-volatile memory chips comprise NAND chips, wherein at least one of the plurality of channels is coupled to a different number of NAND chips in comparison to other channels of the plurality of channels.

In example 19, the subject matter of claim 12 may include that may include that the non-volatile memory chips comprise NAND chips, wherein if the one or more read requests are not placed in the determined lightly loaded channel for the processing then read performance on the apparatus decreases by over 10% in comparison to another apparatus in which all channels are coupled to a same number of NAND chips.

In example 20, the subject matter of claim 12 may include that the allocating of the resources for the processing is performed subsequent to determining by the arbiter in the apparatus which of the plurality of channels in the apparatus is the lightly loaded channel.

In example 21, the subject matter of claim 12 may include that the arbiter polls relatively lightly loaded channels more often than relatively heavily loaded channels to preferentially dispatch re-ordered read requests to the relatively lightly loaded channels.

In example 22, the subject matter of claim 12 may include associating with each of the plurality of channels a data structure that maintains outstanding reads that are being processed by the channel; and maintaining the one or more read requests that have been received from the host in an incoming queue of read requests received from the host.

Example 23 is a system, comprising a solid state drive, a display, and a processor coupled to the solid state drive and the display, wherein the processor sends a plurality of read requests to the solid state drive, and wherein in response to the plurality of read requests, the solid state drive performs operations, the operations comprising: determine which of a plurality of channels in the solid state drive is a lightly loaded channel in comparison to other channels in the solid state drive; allocate resources for processing one or more read requests selected from the plurality of read requests, wherein the one or more read requests are intended for the determined lightly loaded channel; place the one or more read requests in the determined lightly loaded channel for the processing.

In example 24, the subject matter of claim 23 further comprises that the solid state drive further comprises a plurality of non-volatile memory chips including NAND or NOR chips, wherein the lightly loaded channel is a most lightly loaded channel in the plurality of channels, and wherein subsequent to placing the one or more read requests in the determined most lightly loaded channel for the processing, the determined most lightly loaded channel is as close to being fully utilized as possible during the processing.

In example 25, the subject matter of claim 23 further comprises that an order of processing of the plurality of requests is modified by the placing of the one or more read requests in the determined lightly loaded channel for the processing.

What is claimed is:

1. A method, comprising:
determining, by an arbiter in a solid state drive, which of a plurality of channels in the solid state drive is a lightly loaded channel in comparison to other channels;
allocating resources for processing one or more read requests intended for the determined lightly loaded channel, wherein the one or more read requests have been received from a host; and
placing the one or more read requests in the determined lightly loaded channel for the processing.

2. The method of claim 1, wherein the determined lightly loaded channel is a most lightly loaded channel in the plurality of channels, and wherein subsequent to placing the one or more read requests in the determined most lightly loaded channel for the processing, the determined most lightly loaded channel is as close to being fully utilized as possible during the processing.

3. The method of claim 1, wherein the one or more read requests are included in a plurality of read requests intended for the plurality of channels, and wherein an order of processing of the plurality of read requests is modified by the placing of the one or more read requests in the determined lightly loaded channel for the processing.

4. The method of claim 3, wherein modifying the order of processing of the plurality of requests preferentially processes the one or more read requests intended for the determined lightly loaded channel over other requests.

5. The method of claim 1, the method further comprising:
receiving, by the solid state drive, the one or more read requests from the host via a peripheral component interconnect express (PCIe) bus, wherein each of the plurality of channels in the solid state drive has an identical bandwidth.

6. The method of claim 5, wherein a sum of bandwidths of the plurality of channels equals a bandwidth of the PCIe bus.

7. The method of claim 1, wherein at least one of the plurality of channels is coupled to a different number of NAND chips in comparison to other channels of the plurality of channels.

8. The method of claim 1, wherein if the one or more read requests are not placed in the determined lightly loaded channel for the processing then read performance on the solid state drive decreases by over 10% in comparison to another solid state drive in which all channels are coupled to a same number of NAND chips.

9. The method of claim 1, wherein the allocating of the resources for the processing is performed subsequent to determining by the arbiter in the solid state drive which of the plurality of channels in the solid state drive is the lightly loaded channel.

10. The method of claim 1, wherein the arbiter polls relatively lightly loaded channels more often than relatively heavily loaded channels to preferentially dispatch re-ordered read requests to the relatively lightly loaded channels.

11. The method of claim 1, the method further comprising:
associating with each of the plurality of channels a data structure that maintains outstanding reads that are being processed by the channel; and
maintaining the one or more read requests that have been received from the host in an incoming queue of read requests received from the host.

12. An apparatus, comprising:
a plurality of non-volatile memory chips;
a plurality of channels coupled to the plurality of non-volatile memory chips; and
an arbiter for controlling the plurality of channels, wherein the arbiter is operable to:
determine which of the plurality of channels is a lightly loaded channel in comparison to other channels;
allocate resources for processing one or more read requests intended for the determined lightly loaded channel, wherein the one or more read requests have been received from a host; and
place the one or more read requests in the determined lightly loaded channel for the processing.

13. The apparatus of claim 12, wherein the non-volatile memory chips comprise NAND chips, wherein the lightly loaded channel is a most lightly loaded channel in the plurality of channels, and wherein subsequent to placing the one or more read requests in the determined most lightly loaded channel for the processing, the determined most lightly loaded channel is as close to being fully utilized as possible during the processing.

14. The apparatus of claim 12, wherein the one or more read requests are included in a plurality of read requests intended for the plurality of channels, wherein the plurality of read requests are received from the host, and wherein an order of processing of the plurality of read requests is modified by the placing of the one or more read requests in the determined lightly loaded channel for the processing.

15. The apparatus of claim 14, wherein modifying the order of processing of the plurality of requests preferentially processes the one or more read requests intended for the determined lightly loaded channel over other requests.

16. The apparatus of claim 12, wherein the apparatus receives the one or more requests from the host via a peripheral component interconnect express (PCIe) bus, wherein each of the plurality of channels has an identical bandwidth.

17. The apparatus of claim 16, wherein a sum of bandwidths of the plurality of channels equals a bandwidth of the PCIe bus.

18. The apparatus of claim 12, wherein the non-volatile memory chips comprise NAND chips, and wherein at least one of the plurality of channels is coupled to a different number of NAND chips in comparison to other channels of the plurality of channels.

19. The apparatus of claim 12, wherein the non-volatile memory chips comprise NAND chips, and wherein if the one or more read requests are not placed in the determined lightly loaded channel for the processing then read performance decreases by over 10% in comparison to another apparatus in which all channels are coupled to a same number of NAND chips.

20. The apparatus of claim 12, wherein the allocating of the resources for the processing is performed subsequent to determining by the arbiter which of the plurality of channels is the lightly loaded channel.

21. The apparatus of claim 12, wherein the arbiter polls relatively lightly loaded channels more often than relatively heavily loaded channels to preferentially dispatch re-ordered read requests to the relatively lightly loaded channels.

22. The apparatus of claim 12, wherein the arbiter is further operable to:
associate with each of the plurality of channels a data structure that maintains outstanding reads that are being processed by the channel; and
maintain the one or more read requests that have been received from the host in an incoming queue of read requests received from the host.

23. An system, comprising:
a solid state drive;
a display; and
a processor coupled to the solid state drive and the display, wherein the processor sends a plurality of read requests to the solid state drive, and wherein in response to the plurality of read requests, the solid state drive performs operations, the operations comprising:
determine which of a plurality of channels in the solid state drive is a lightly loaded channel in comparison to other channels in the solid state drive;
allocate resources for processing one or more read requests selected from the plurality of read requests, wherein the one or more read requests are intended for the determined lightly loaded channel; and
place the one or more read requests in the determined lightly loaded channel for the processing.

24. The system of claim 23, wherein solid state drive further comprises a plurality of non-volatile memory chips including NAND or NOR chips, wherein the lightly loaded channel is a most lightly loaded channel in the plurality of channels, and wherein subsequent to placing the one or more read requests in the determined most lightly loaded channel for the processing, the determined most lightly loaded channel is as close to being fully utilized as possible during the processing.

25. The system of claim 23, wherein an order of processing of the plurality of requests is modified by the placing of the one or more read requests in the determined lightly loaded channel for the processing.
